(19) United States
(12) Patent Application Publication
(10) Pub. No.: US 2025/0183328 A1
(43) Pub. Date: Jun. 5, 2025

(54) METHOD FOR COMMINUTING SPENT, CATALYST-COATED POLYMER ELECTROLYTE MEMBRANES

(71) Applicant: HERAEUS PRECIOUS METALS GMBH & CO. KG, Hanau (DE)

(72) Inventors: Bernhard BAUER-SIEBENLIST, Hanau (DE); Marco STEMMLER, Hanau (DE); Christian KRAUSHAAR, Hanau (DE)

(21) Appl. No.: 18/842,225

(22) PCT Filed: Jan. 26, 2023
(86) PCT No.: PCT/EP2023/051849

§ 371 Date: Aug. 28, 2024

(30) Foreign Application Priority Data
Mar. 2, 2022 (EP) 22159593.7

(51) Int. Cl. H01M 8/008; C22B 7/00; C22B 11/02

(52) U.S. Cl. CPC H01M 8/008; C22B 7/005; C22B 7/009; C22B 11/026

(57) ABSTRACT

A method for comminuting spent, catalyst-coated PEM membranes from PEM fuel cells and/or PEM electrolysis cells by means of a cutting mill.

The invention relates to a method for comminuting spent, catalyst-coated polymer electrolyte membranes (hereinafter abbreviated as “PEM membrane” or simply “PEM”) from PEM fuel cells and/or PEM electrolysis cells by means of a cutting mill.

In PEM fuel cells and in PEM electrolysis cells, the respective half-cells are separated from one another by means of a PEM membrane, in particular by means of a PEM membrane provided with an elastic seal. So-called ionomers such as, in particular, copolymers of tetrafluoroethylene and a sulfonic acid group-containing (per)fluorovinyl ether, for example Nafion® from Chemours, are common as the actual PEM material. The PEM membrane functions as a proton transport medium and electrically isolates the electrodes of the PEM fuel cell or PEM electrolysis cell from one another. The front and rear sides of the PEM membrane typically comprise a noble metal-containing catalyst layer. It is possible for a PEM membrane to further comprise an electrically conductive, porous gas diffusion layer (e.g. in the form of a carbon paper or carbon fiber fabric) applied to the catalyst layer. The catalytically active noble metal(s) contained in the catalyst layer can be, for example, platinum, rhodium, palladium, iridium and/or ruthenium, in particular one or more of the noble metals platinum, iridium and ruthenium, wherein the respective noble metal may be present as a catalytically active species in elemental (metallic) form and/or in chemically bound form. In general, the catalyst layer comprises the noble metal(s) in supported form, i.e. on a support, for example made of a carbon material or an oxidic material. Based on the catalyst-coated PEM membrane plus any elastic seal that may be present plus any gas diffusion layer that may be present, the noble metal content or total noble metal content can be, for example, in the range of 0.1 to 10 wt. %.

The spent, catalyst-coated PEM membranes that may be provided with an elastic seal can comprise an area, for example, in the range of 5 to 5000 cm²; the large area range specified here as an example results from the fact that the PEM membranes can originate from laboratory equipment through to commercial plants. When considering individual cases, the proportion by weight of any elastic seal that may be present can, for example, be in the range of 10 to 50 wt. %, based on the sum of the proportions by weight of the elastic seal and the catalyst-coated PEM membrane.

As stated, the catalyst-coated PEM membranes discussed herein can in particular be provided with an elastic seal. Such an elastic seal is designed at least as an outer sealing profile or outer edge seal, which completely encloses or surrounds the edge or the perimeter of the PEM membrane. This serves to effectively seal the individual chambers of the half-cells from the outside. The material of the seal is elastic, for example a corresponding elastic material made of or based on rubber, caoutchouc, silicone or other elastomeric plastics. Needless to say and as is clear to a person skilled in the art, the elastic material as such is free of noble metal or at least substantially free of noble metal.

At the end of the operating or useful life of said PEM membranes or their noble metal-containing catalyst layer, the relevant PEM fuel cells or PEM electrolysis cells or the PEM membranes installed therein must be replaced. As a result of the valuable noble metal(s) contained in the catalyst layer(s) of the PEM membranes, spent PEM membranes are not simply disposed of, but sent for noble metal recycling. As a result, there is a need to comminute and homogenize such PEM membranes or an assortment of various such PEM membranes, on the one hand as preparation for actual noble metal recycling, and on the other hand with the aim of obtaining a material that allows representative sampling and determination of the noble metal content based on such a representative sample.

In searching for a method that would achieve the aforementioned object, it has been found that comminution can be performed effectively by means of a cutting mill. The present invention therefore consists of a method for comminuting spent, catalyst-coated PEM membranes from PEM fuel cells and/or PEM electrolysis cells, characterized in that the comminution is performed by means of a cutting mill. The spent, catalyst-coated PEM membranes and in particular spent, catalyst-coated PEM membranes provided with an elastic seal therefore represent grinding material to be comminuted by means of a cutting mill.

With regard to catalyst-coated PEM membranes or catalyst-coated PEM membranes provided with an elastic seal, reference is made to the aforementioned. These can be identical or different catalyst-coated PEM membranes or identical or different catalyst-coated PEM membranes provided with an elastic seal. Different catalyst-coated PEM membranes—with or without an elastic seal—can, for example, originate from different sources and, for example, arrive unsorted as a batch at a recyclable waste collector and thus reach an operator of the method according to the invention. In such a case, the different PEM membranes may differ, for example, in terms of manufacture, shape, size, type(s) and content of noble metal in the catalyst layer, type of membrane material, presence of an elastic seal and/or type of elastic seal.

The method according to the invention can be carried out batchwise (discontinuously) or continuously.

It is expedient to operate the method according to the invention with dry or dried grinding material to be comminuted.

Although not preferred, the method according to the invention can be carried out with cooling of the grinding material to be comminuted, for example by adding dry ice or liquid nitrogen to the product before or during the comminution thereof.

According to the invention, the comminution itself is performed in a conventional cutting mill known to a person skilled in the art. Such cutting mills are manufactured and sold, for example, by Retsch GmbH, Haan or by Fritsch GmbH, Idar-Oberstein.

The comminution process can be performed until a desired comminution result is achieved, for example in the form of a desired maximum particle size of the grinding material, for example in the range of 1 to 10 mm in the direction of the greatest longitudinal extension of the particles formed during comminution. As can be seen from the above, the comminuted grinding material can be a mixture of comminuted catalyst-coated PEM membrane and comminuted elastic seal. A maximum particle size of the grinding material can be adjusted depending on the cutting mill used (model and tool used therein) via the parameters (i) energy input during the comminution process and/or (ii) duration of the comminution process.

When carrying out the method according to the invention in batches, but in particular when carrying out the method according to the invention with an assortment of spent, catalyst-coated PEM membranes optionally comprising elastic seals, it may be expedient to mix the comminuted grinding material before further processing or use for the purpose of further homogenization.

One or more samples can be taken from the comminuted and, if necessary, additionally mixed grinding material in order to determine the average noble metal content. The comminuted grinding material can otherwise be subjected to a conventional noble metal recycling process which can generally comprise a plurality of sub-processes. In this respect, the method according to the invention can comprise one or more corresponding method steps that take place after the comminution; for example, after the comminution has been completed, the method according to the invention comprises at least one recycling or processing step, which is selected from the steps of ashing (burning off) and hydrometallurgical processing.

In the case of grinding material to be comminuted in the form of spent, catalyst-coated PEM membranes provided with an elastic seal, in a preferred embodiment of the method according to the invention, use can advantageously be made of a different comminution behavior or a different comminution capability or grindability of the two different material fractions of the grinding material, more precisely its fraction of elastic seal and its fraction of catalyst-coated PEM membrane. It could thus be determined within the scope of the development of the method according to the invention that the fraction formed from catalyst-coated PEM membrane can be comminuted more quickly or more easily than the fraction formed from elastic seal. The comminution is carried out until a desired comminution result is achieved with regard to the fraction of catalyst-coated PEM membrane in the comminuted grinding material, for example in the form of a desired maximum particle size of the fraction of catalyst-coated PEM membrane in the comminuted grinding material, while the particle size of the elastic seal fraction is coarser and therefore greater than the maximum particle size of the catalyst-coated PEM membrane fraction. A desired maximum particle size of the fraction of catalyst-coated PEM membrane in the comminuted grinding material can be, for example, in the range of a few millimeters, for example in the range of 1 to 5 mm in the direction of the greatest longitudinal extension of the particles in question.

After completion of the comminution process carried out according to the preferred embodiment of the method according to the invention, a or the coarse-grained fraction of comminuted elastic seal can be separated from a or the fine-grained fraction of catalyst-coated PEM membrane, for example by means of screening. This fine-grained fraction can then be sampled in analogy to the above, analyzed with regard to the type and proportion of noble metal and/or subjected to noble metal recycling.

The aforementioned separation or screening that takes place after the comminution process can be performed by means of a separate screening device; in an expedient and advantageous embodiment, it can be practically performed during the comminution process by means of a screening device integrated into the cutting mill. Examples of such screening devices include bottom screens, for example those with round perforations in the diameter range of 1 to 5 mm or with square perforations of 1 mm×1 mm to 5 mm×5 mm. In other words, the comminution process according to the invention can, in the case of its preferred embodiment, be implemented in a sort-separating manner in the sense of a grinding and screening process taking place in parallel.

The preferred embodiment of the method according to the invention makes it possible to perform the aforementioned sampling, the aforementioned noble metal analysis and/or the aforementioned noble metal recycling substantially solely or substantially solely with the fine-grained noble metal-containing fraction of the comminuted grinding material. The coarse-grained fraction of comminuted elastic seal obtained separately can be used for other purposes, for example as an additive in floor or road surfaces.

### EXEMPLARY EMBODIMENT

93.88 g of spent, catalyst-coated polymer electrolyte membranes from PEM fuel cells provided with edge seals made of silicone elastomer were comminuted in a cutting mill (model SM 300 from Retsch GmbH, Retsch-Allee 1-5, 42781 Haan, Germany) equipped with a bottom screen with square perforations of 3 mm×3 mm in batch operation lasting 30 seconds. This resulted in 76.33 g of fine-grained fraction and 17.55 g of coarse-grained, above-screen fraction. After ashing and wet-chemical processing of the ash residue, both fractions were examined for their noble metal content by means of ICP-OES. The following table shows the results obtained for the two fractions:

| | Fine-grained fraction | Above-screen fraction |
|---|---|---|
| Weight | 76.33 g | 17.55 g |
| Particle size | >0 to 3 mm | >3 to 6 mm |
| Platinum content | 2.62 wt. % | 0.12 wt. % |
| Ruthenium content | 0.22 wt. % | 0.01 wt. % |

1. A method for comminuting spent, catalyst-coated PEM membranes from PEM fuel cells and/or PEM electrolysis cells, wherein the comminution is performed by means of a cutting mill.

2. The method according to claim 1, wherein the spent, catalyst-coated PEM membranes are provided with elastic seals.

3. The method according to claim 1, wherein the catalyst-coated PEM membranes are identical or different catalyst-coated PEM membranes.

4. The method according to claim 1, wherein the method is carried out batchwise or continuously.

5. The method according to claim 1, wherein the comminution process is performed until a desired comminution result is achieved.

6. The method according to claim 2, wherein the comminution is performed only until a desired comminution result is achieved with regard to the fraction of catalyst-coated PEM membrane in the comminuted grinding material.

7. The method according to claim 2, wherein, after the comminution process has ended, the coarse-grained fraction of comminuted elastic seal is separated from the fine-grained fraction of catalyst-coated PEM membrane.

8. The method according to claim 7, wherein the separation is performed by means of screening.

9. The method according to claim 7, wherein the separated fine-grained fraction is sampled, analyzed with regard to the type and proportion of noble metal and/or subjected to noble metal recycling.

10. The method according to claim 7, wherein the separation or screening is performed during the comminution process by means of a screening device integrated into the cutting mill.
